(19) United States
(12) Patent Application Publication
(10) Pub. No.: US 2015/0093925 A1
(43) Pub. Date: Apr. 2, 2015

(54) Adapter For Contacting Bus Bars

(71) Applicant: Klaus Bruchmann GmbH, Weisskirchen an der Traun (AT)

(72) Inventor: Klaus Bruchmann, Coburg (DE)

(21) Appl. No.: 14/499,969

(22) Filed: Sep. 29, 2014

(30) Foreign Application Priority Data
Sep. 30, 2013 (DE) 102013110789.3

(51) Int. Cl. H01R 13/629; H01B 17/38; H01R 4/48

(52) U.S. Cl. CPC H01R 13/62933; H01R 4/48; H01R 4/489; H01B 17/38
USPC 439/153; 174/113 R

(57) ABSTRACT

An adapter for contacting busbars with a multi-pole connecting cable is disclosed with at least two contact connections for at least two busbars; a housing having holding means; and a cable-connecting device that is secured in the housing by the holding means. The cable-connecting device has: a lever switch; a spring-terminal structure; and a connecting structure. The lever switch has a fulcrum onto which a leverage acts when the lever switch is actuated. The spring-terminal structure provides a spring force for establishing an electrical contact between one of the plurality of poles and one of the at least two contact connections by the spring force after inserting the connecting cable. The connecting structure is arranged between the lever switch and the spring-terminal structure and is designed for transferring the leverage from the lever switch to the spring-terminal structure and to tension the spring-terminal structure counter to the spring force.

### FIELD OF THE INVENTION

The present invention relates to an adapter for contacting busbars (busbar adapter) and in particular an adapter for contacting busbars having a multi-pole connecting cable, thus achieving simultaneous and joint contacting of all poles (lines) of the multi-pole connecting cable.

### BACKGROUND OF THE INVENTION

Busbar adapters are in particular suitable for fastening fuse systems, switch-fuse units etc., but also for all other electrical installation appliances on electrical busbar systems that are used for power supply, in particular three-phase busbar systems being used.

Such busbar adapters are contacted by means of a multi-pole connecting cable that exhibits a plurality of lines (or poles). For example, a three-phase connecting cable exhibits a single line for each phase, in conventional systems each line being fastened individually to the corresponding cable terminal. For this purpose, for example screw, solder, or weld connections have been used so far, as they are for example disclosed in DE 10 2005 009 856 B4.

Since in these systems each line is to be fastened individually to the busbar adapter, more time is required to fasten all lines in a correspondingly secure manner. A further disadvantage of these conventional systems is that removing the cable likewise requires time and that often suitable tools are required for this. Screw-type connections further exhibit the disadvantage that such connections can become loose over time and thus a secure connection often cannot be guaranteed over a longer period of time.

It is therefore the object of the present invention to provide an adapter for contacting busbars with a connecting cable, that enables simple, fast, and secure contacting of a multi-pole connecting cable to a busbar system.

### BRIEF SUMMARY OF THE INVENTION

This object is achieved by an adapter according to claim 1 and a connecting cable according to Claim 12. Claims 2 to 11 and 13 refer to further advantageous embodiments of the present invention.

According to the present invention, an adapter for contacting busbars with a connecting cable, the connecting cable exhibiting at least two poles (lines), comprises the following features: at least two contact connections for at least two busbars, a housing, and a cable-connecting device that is secured in the housing by holding means. The housing comprises the holding means and at least two openings for receiving in each case one pole of the multi-pole connecting cable through each of the at least two openings. The cable-connecting device exhibits: a lever switch; a spring-terminal structure, and a connecting structure. The lever switch comprises a fulcrum onto which a leverage acts when the lever switch is actuated. The spring-terminal structure provides at least one spring force to establish, after inserting the connecting cable, in each case an electrical contact between one of the at least two poles and one of the at least two contact connections by means of the spring force. The connecting structure is arranged between the lever switch and the spring-terminal structure and is designed for transferring the leverage from the lever switch to the spring-terminal structure and to tension the spring-terminal structure counter to the spring force. As a result of single actuation of the lever switch the at least two poles of the connecting cable can be simultaneously guided into the cable-connecting device and by releasing the lever switch the respective electrical contact is established between the at least two contact connections and the at least two poles due to the spring force.

Thus only one lever switch is required to simultaneously insert the at least two poles of the connecting cable into the cable-connecting device and to establish the electrical contact of the at least two busbars to the at least two poles due to the spring force by releasing the lever switch.

In further exemplary embodiments, the connecting structure is optionally of one-part design and exhibits at least two rod-shaped elements, the at least two rod-shaped elements being designed to contact the spring-terminal structure when the leverage acts and to tension it by transmitting the leverage, so that an inserted connecting cable can be removed from the cable-connecting device.

Using the one-part design of the connecting structure it is achieved that reliable opening of the spring-terminal structure is made possible by single actuation of the lever switch without having to move a multiplicity of parts.

In further exemplary embodiments, the lever switch comprises a lever arm for actuation by a user and a propping section, the fulcrum being arranged between the lever arm and the propping section and the propping section coupling to the holding means for defining a pivot, so that the leverage acts on the fulcrum due to a rotation about the pivot when the lever switch is actuated by the user. In addition, the lever switch can optionally exhibit a step-shaped depression and the holding means can exhibit a projection and a supporting element. The supporting element, the projection, and the step-shaped depression are for example designed for forcing the lever switch having the step-shaped depression against the projection due to the spring force and with the propping section against the supporting element to thus form a stop for the lever switch in the housing. In this way it is achieved that on the one hand the lever switch can be moved in an insertion direction of the cable, but on the other hand is secured in the housing by the stop and is thus strongly attached. In particular if the housing is of two-part design, the holding means can thus guarantee that the cable-connecting device still remains firmly secured at least in part of the housing when the housing is removed. For example, the housing in particular exhibits a lower deck and a removable upper deck, and the holding means are formed on the lower deck. The lower deck can, for example, also exhibit an intermediate deck on which the holding means are formed and that can be separated separately from the lower deck.

The term housing includes all holding structures or holding frames to which the individual components can be fastened without necessarily offering sight protection, dust protection, or moisture protection.

As an option, in further exemplary embodiments the spring-terminal structure can exhibit three mutually electrically insulated spring terminals and the at least two rod-shaped elements can exhibit three rod-shaped elements, of which each contacts in each case one of the three spring terminals, so that a three-phase connecting cable can be simultaneously connected for all phases (e.g. in one working step).

The design of the lever switch having a corresponding lever action has the advantage that all contacts between poles in the connecting cable and to the corresponding busbars can be established simultaneously since the leverage can be correspondingly set via the lever arm so that it is sufficient for contacting all spring terminals simultaneously. Since the spring force for the contact action of the spring terminals is to be correspondingly high, so that secure contacting between the busbar adapter and the connecting cable is guaranteed, in further exemplary embodiments it is advantageous to select the length of the lever arm such that the achievable force action at the fulcrum is sufficient to overcome the spring force that acts in the opposite direction due to the spring terminals and to make possible simple switching of the lever switch by a user.

The spring-terminal structure for example provides a spring force that is sufficient for independently holding the connecting cable in the adapter counter to a pulling force (e.g. the pulling force can at least be of such a magnitude as the weight force that the busbar adapter would exert when lifting due to its weight). The holding force between the spring-terminal structure and the poles of the connecting cable can for example be increased further by correspondingly roughening a surface of the spring-terminal structure and/or of an opposite press face of the contact connection for the busbars so that increased friction takes care that sliding of the at least two poles out of the spring-terminal structure is suppressed or prevented.

As an option, in further exemplary embodiments the spring-terminal structure can be designed such that the connecting cable is wedged after the connecting cable has been guided in, to block the connecting cable from being pulled out of the cable-connecting device.

Wedging of the individual lines of the connecting cable can for example be facilitated in that the spring terminals (that e.g. can be designed as leaf springs) exhibit at their ends, by means of which they contact the at least two poles of the connecting cable, edges that press themselves into the corresponding line of the connecting cable when a pulling force acts on the connecting cable (counter to the insertion direction) and thus prevents a simple pulling-out. In addition, the length of the leaf spring can be greater than the distance from opposite legs of a U-shaped contact connection, so that folding-out of the spring terminals or of the leaf spring is impossible without the leaf spring being deformed. The result would be that an inserted cable is wedged in by the leaf spring after being inserted and simple pulling-out is impossible.

In further exemplary embodiments, the spring-terminal structure can therefore exhibit in each case a leaf spring and U-shaped contact connection having two legs that are opposite each other, the leaf spring being secured to one of the legs such that the spring force acts at least partly in the direction of the other leg, to contact the at least two poles of the connecting cable by the leaf spring and the other leg. As an option it is for example the leaf spring itself that represents a leg of the U-shaped contact connection. Thus the U-shaped contact connection has the advantage that a greater wedging action can be achieved by the combination with a leaf spring, so that even a lower spring force of the spring terminals is sufficient to guarantee, that the connecting cable is reliably secured in the busbar adapter.

As an option, in further exemplary embodiments for the busbar adapter the at least two rod-shaped elements of the connecting structure can be three rod-shaped elements, and the busbar adapter can further provide a guide structure for the three rod-shaped elements so that the three rod-shaped elements can be moved in the insertion direction of the connecting cable when the lever switch is actuated.

Exemplary embodiments also refer to a connecting cable for a previously described adapter, the connecting cable exhibiting at least two lines and a plug and the plug being designed to keep the at least two lines at a predetermined distance from each other, the predetermined distance being selected such that the at least two lines can be guided into the openings of the adapter, in particular without bending the lines.

As an option, in further exemplary embodiments for the connecting cable the at least two lines can be three lines that are arranged in a plane, and the plug can be designed such that the three lines are arranged in parallel in a plane such that two of the three lines exhibit approximately the same distance from an intermediate third line (i.e. they are arranged centrally).

### BRIEF DESCRIPTION OF THE DRAWINGS

The invention is described in more detail below with reference to the accompanying figures:

FIGS. 1A-1D show three-dimensional views of a cable-connecting device of an adapter according to an exemplary embodiment of the present invention;

FIGS. 2A, 2B show two three-dimensional views that illustrate a multi-pole connecting cable having an adapter being connected by means of a plug according to exemplary embodiments; and

FIGS. 3A-3J show cross-sectional views of the adapter in which the cable-connecting device according to exemplary embodiments of the present invention is inserted.

### DETAILED DESCRIPTION OF THE PREFERRED EMBODIMENTS

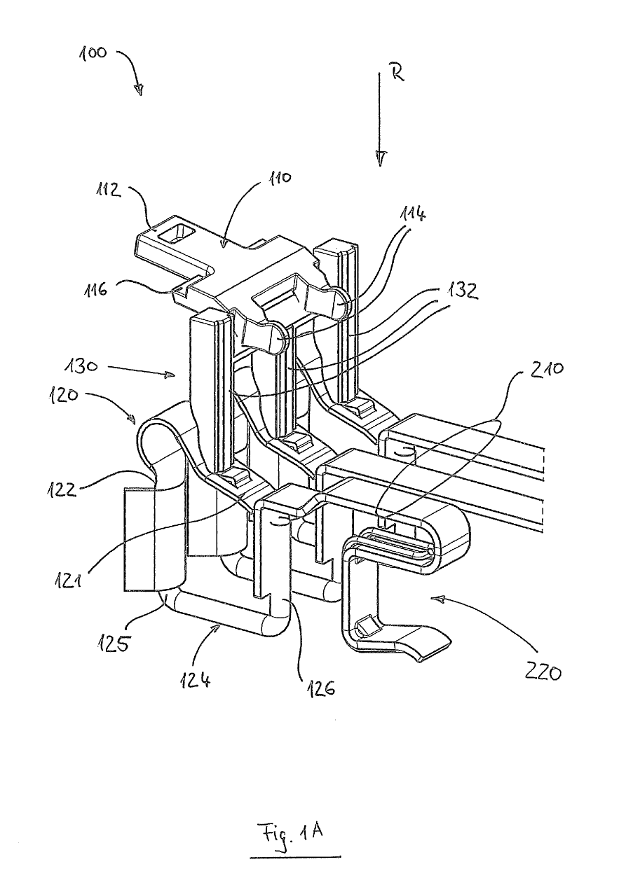

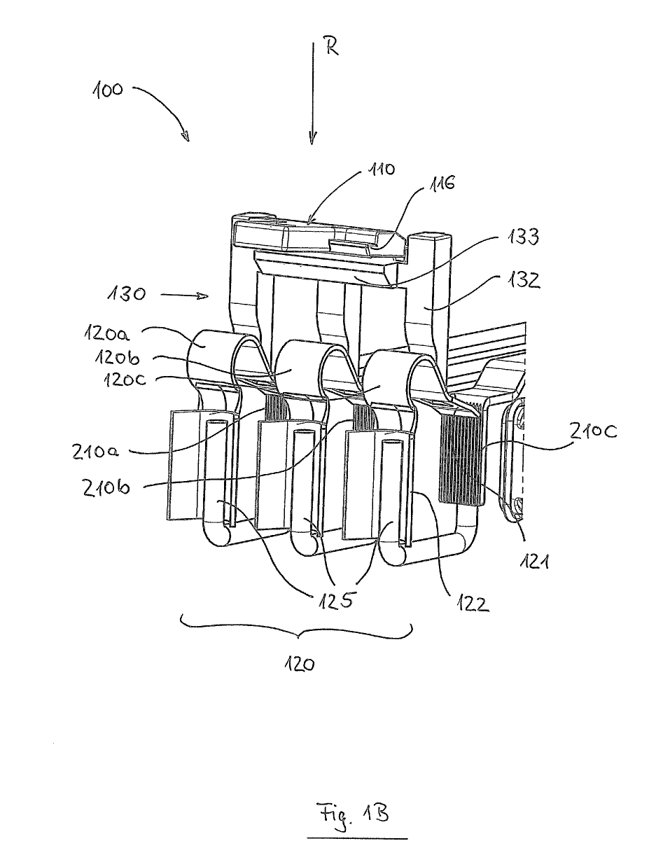

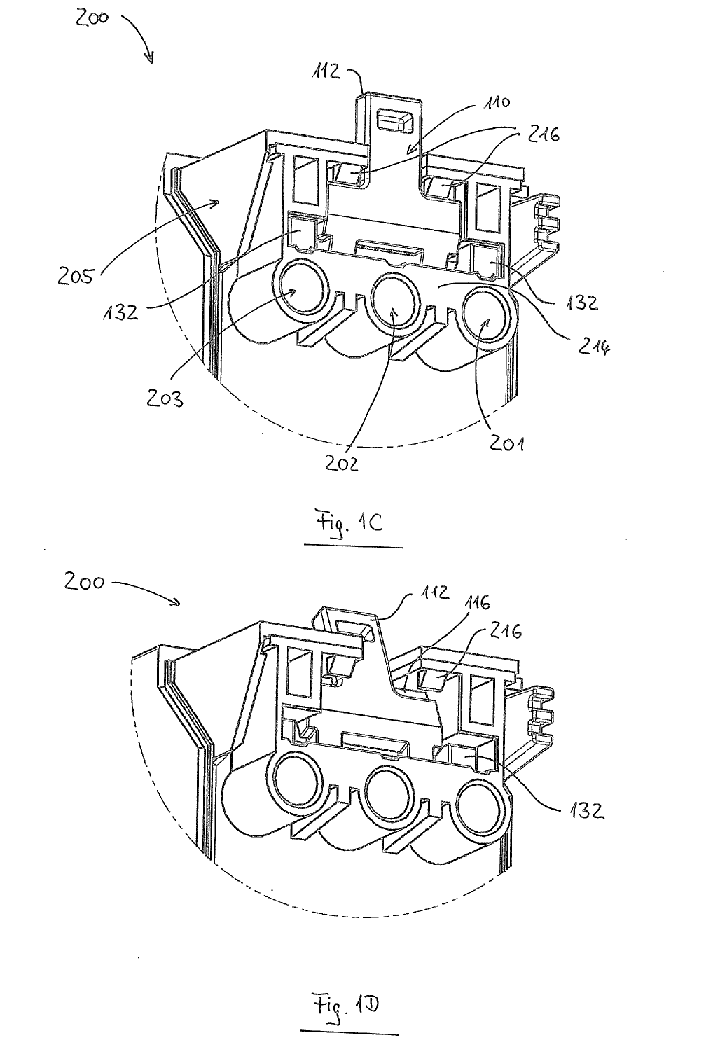

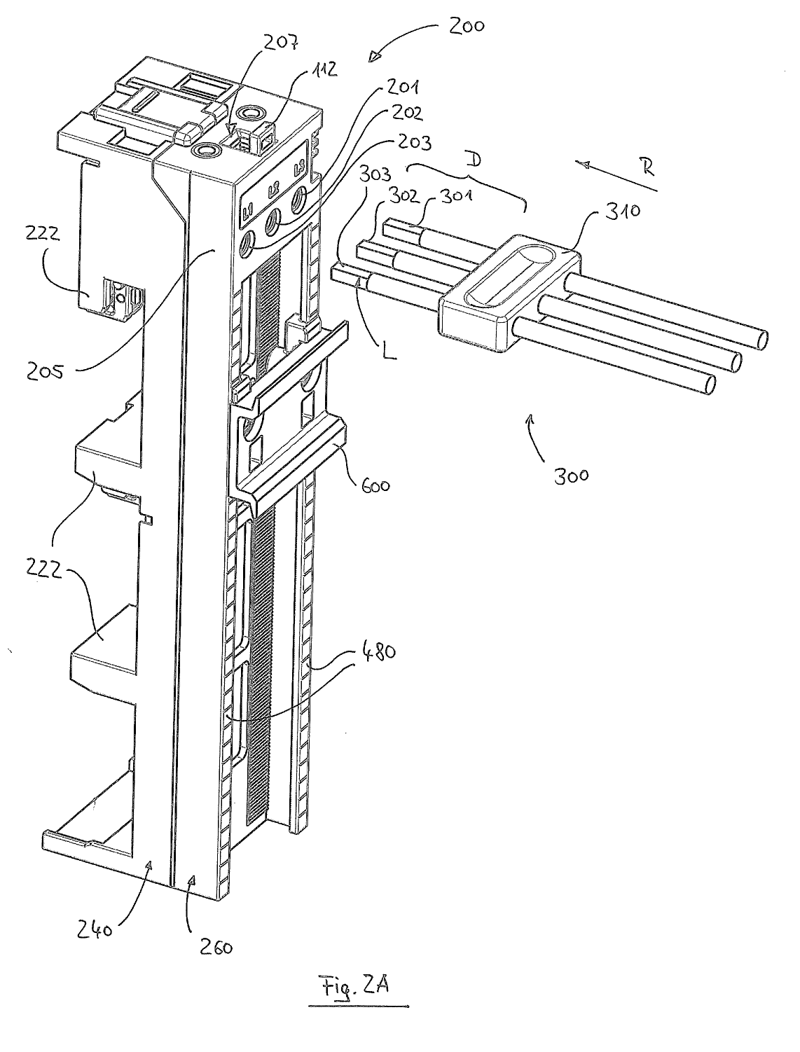

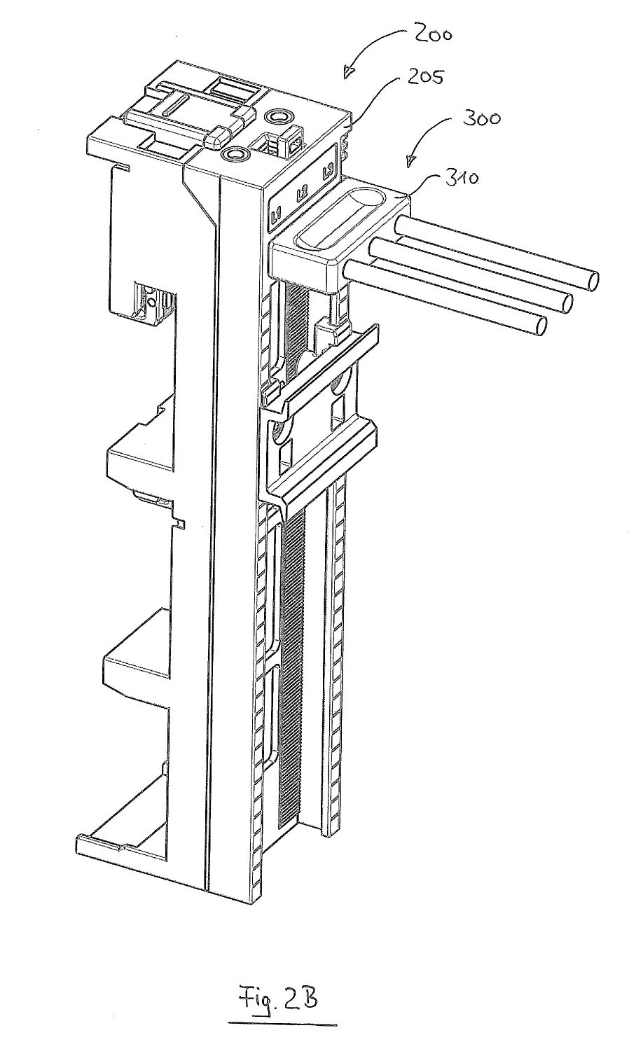

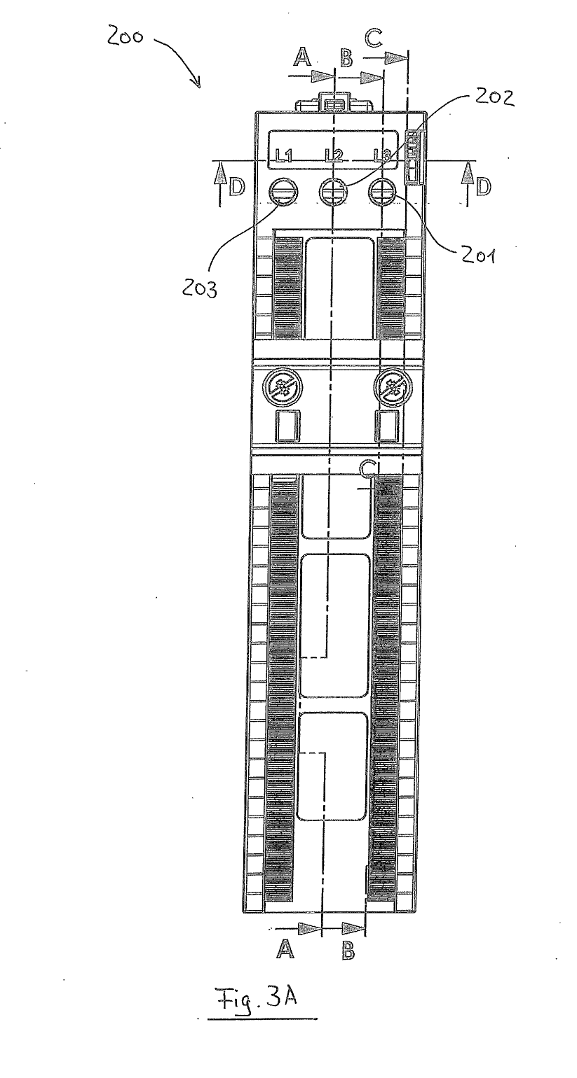

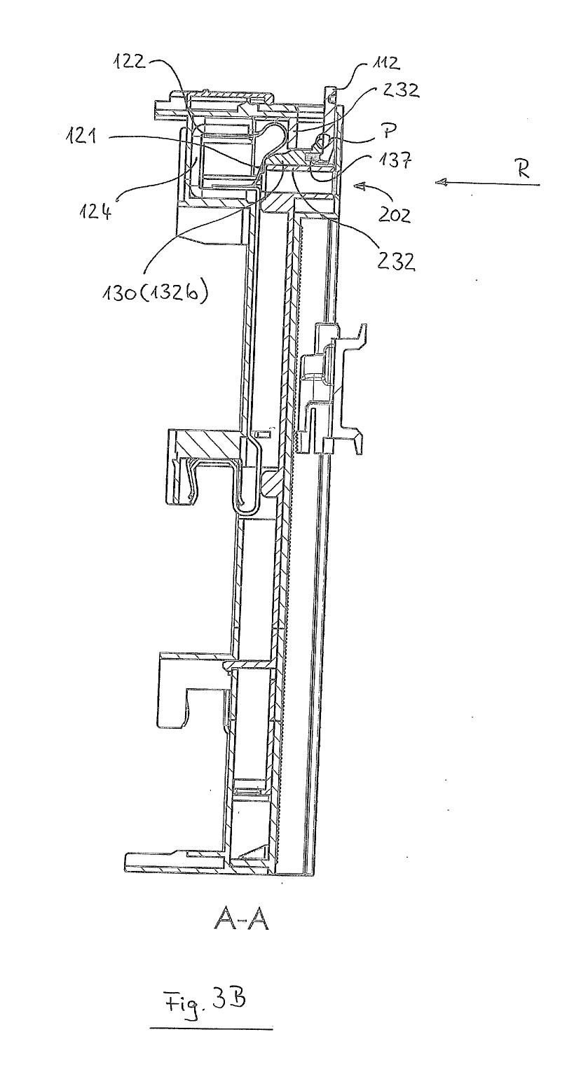

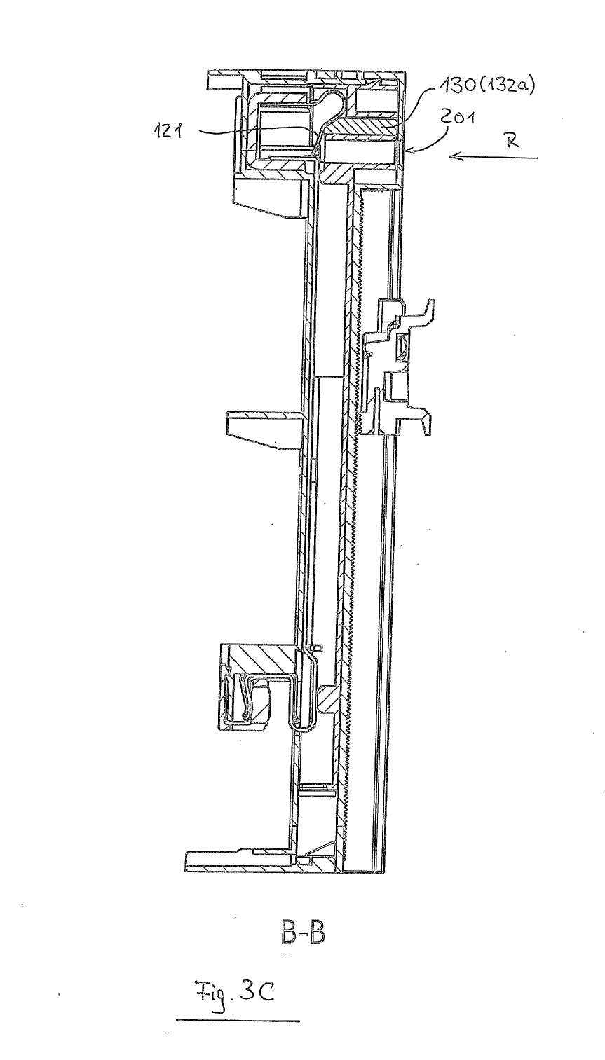

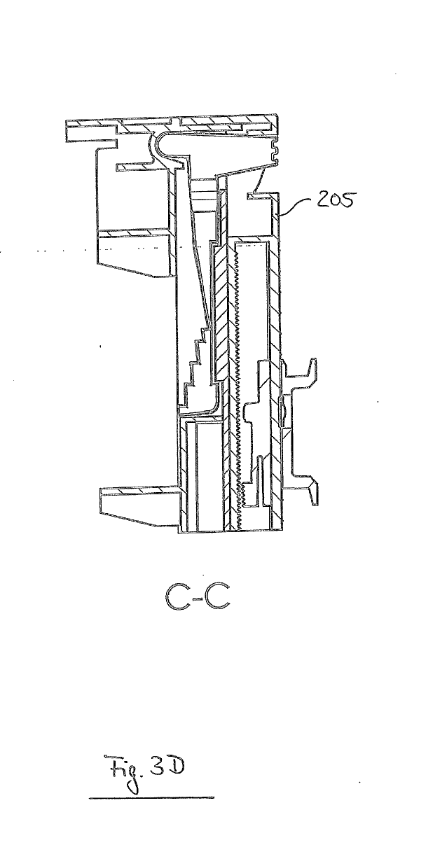

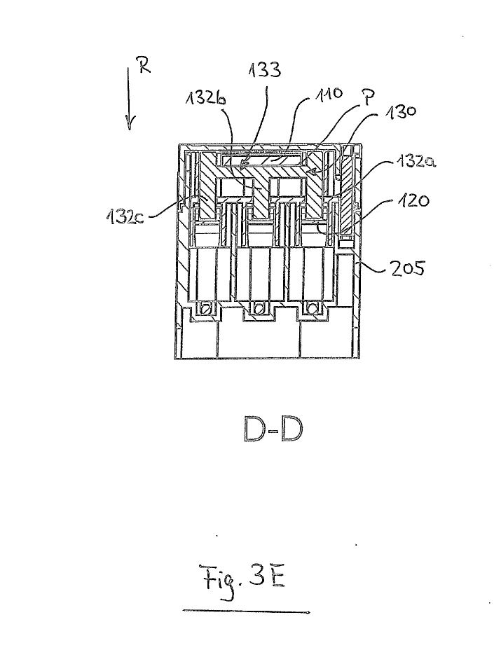

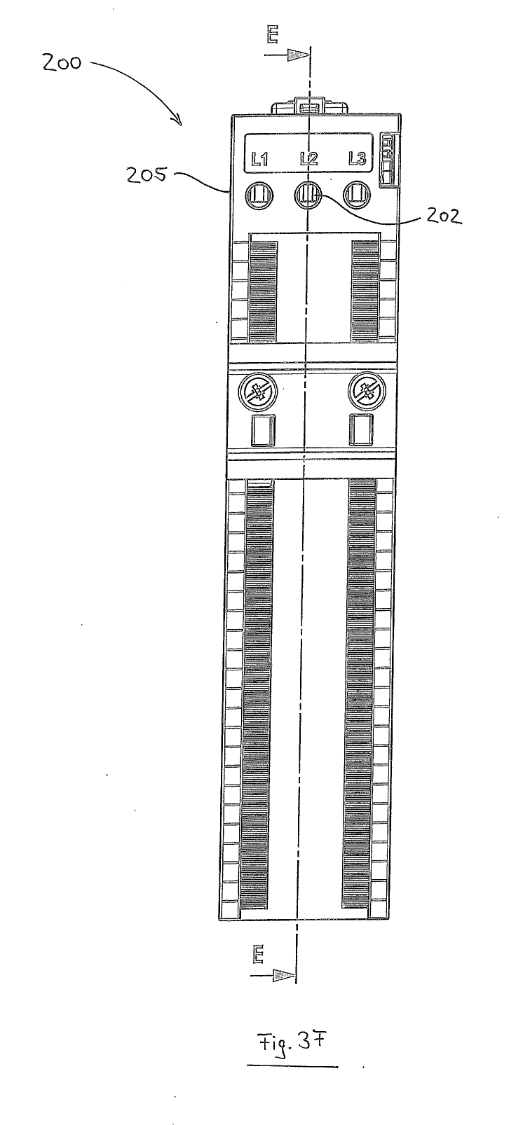

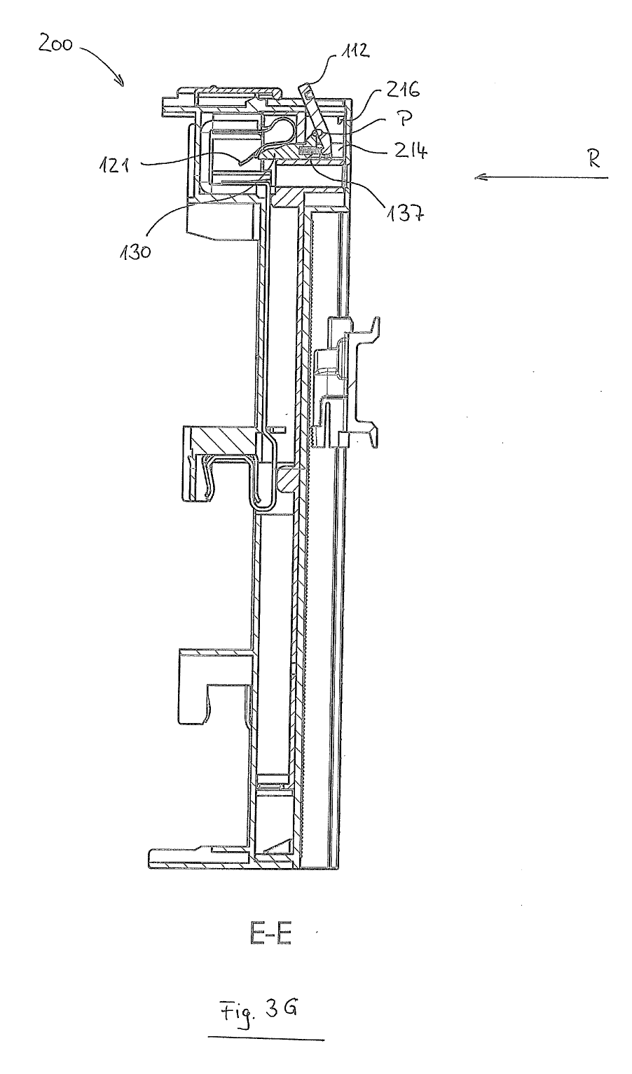

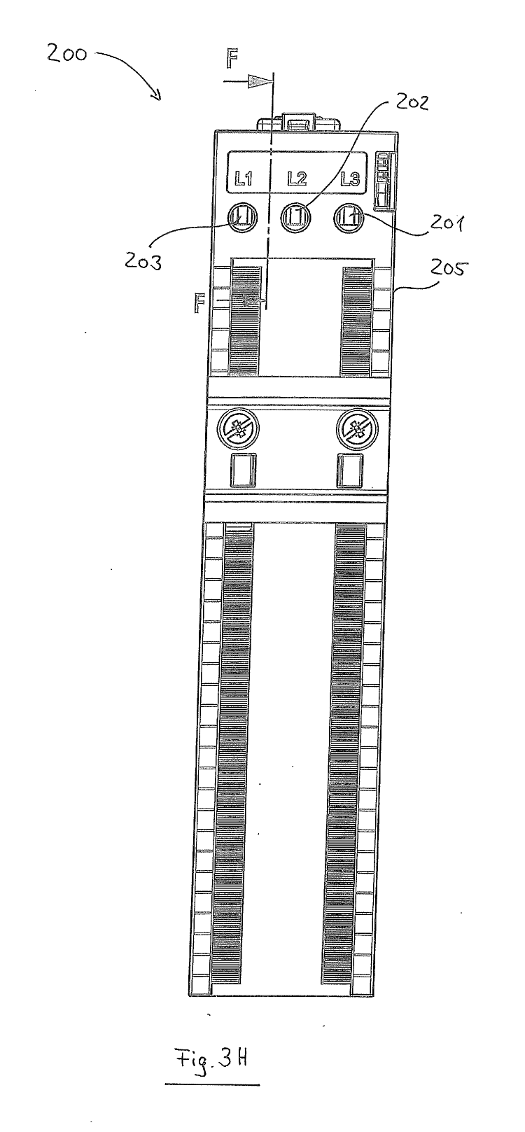

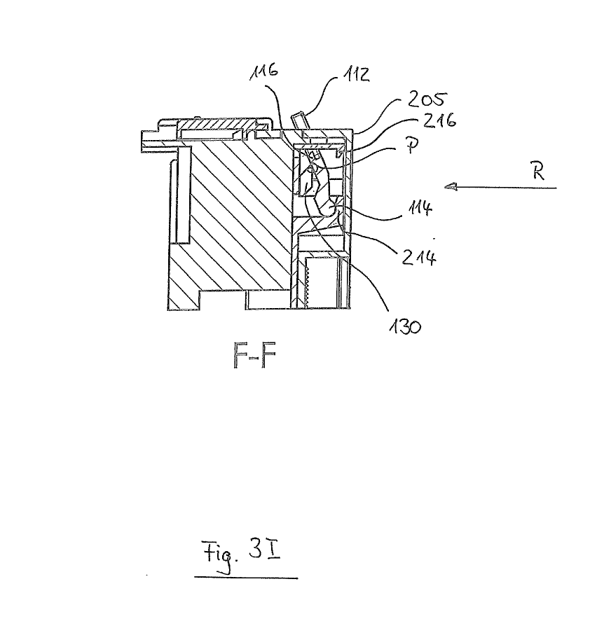

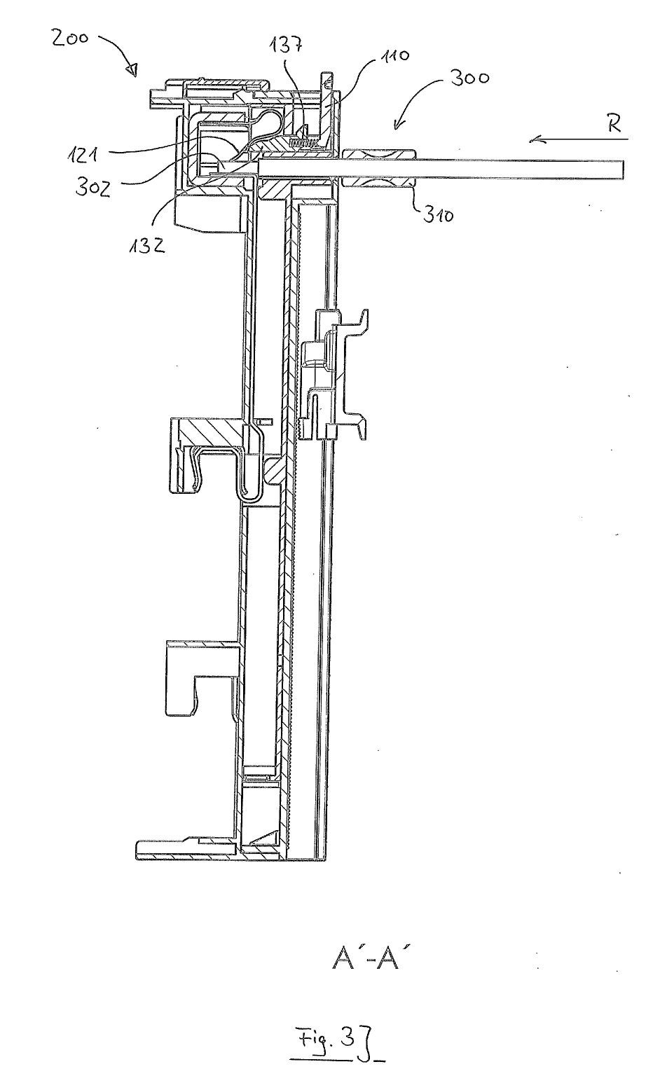

FIGS. 1A and 1B show a cable-connecting device 100 that can be inserted into an adapter, and FIGS. 1C and ID show an enlarged detail of the adapter 200 with an inserted cable-connecting device 100. The connecting cable is described in more detail below using FIGS. 2A and 2B, and further details of the adapter can be gathered from the cross-sectional views of FIGS. 3A-3I.

The cable-connecting device 100 exhibits a lever switch 110, a connecting structure 130, and in this exemplary embodiment three spring terminals as spring-terminal structure 120. The lever switch 110 exhibits a lever arm 112 and opposite a propping structure or a propping section 114, a fulcrum P (that is concealed in the figure) contacting the connecting structure 130 between the lever arm 112 and the propping structure 114. The propping structure 114 for examples serves as a pivot for the lever arm 112, so that the propping section 114 rotates relative to a housing when the lever switch 110 is actuated, but is not shifted transversally.

The connecting structure 130, that is for example of one-part design, exhibits for example three propping rods 132 (rod-shaped elements or plungers) that extend in a guiding-in direction R (insertion or plug-in direction) of the multi-pole connecting cable and in each case contact one of the three spring terminals 120 at an end opposite the fulcrum P. The in each case one spring terminal 120 is in each case connected to a U-shaped connecting part (U-shaped contact connection) 124. The U-shaped connecting part 124 exhibits two opposite legs 125, 126 of which at one leg 125 the spring terminal 120 is arranged and to the other leg 126 in each case an end of a contact connection 210 for a busbar is fastened. The lever switch 110 and/or the connecting structure 130 preferably exhibit an electrically insulating material.

According to exemplary embodiments of the present invention the lever switch 110 further exhibits a step-shaped depression 116 that provides an upper stop for a movement counter to the plug-in direction R, so that the lever switch 110 can be held under tension in the housing by the spring force (see FIG. 1C).

The lever switch 110 illustrated is therefore designed so as to exploit a lever action that arises along a lever arm that is supported at a supporting point (not shown in FIG. 1A) and produces a lever force at the fulcrum if the user applies a force at the end of the lever arm 112. Using the present invention, it is thus possible that all contacts between the connecting cable and the contact connections 210 can be established simultaneously or at short intervals one after the other, however in one working step, so that no separate contacting of the individual lines is necessary. By a single actuation of the lever switch 110, the user can thus contact all lines of the connecting cable with the corresponding contact connections 210 in the adapter and likewise separate in a single working step all lines of the connecting cable from the contact connections 210 and thus from the busbars. For this, no multiple working steps are requisite, but only a single actuation of the lever switch 110.

Each of the three spring terminals 120 can be designed as a leaf spring having a spring arm 121 and provides a spring force that presses the spring arm 121 fully or partly toward the other leg 126 of the U-shaped connecting part 124 to establish in this way a contact between the respective line of the connecting cable and the respective contact connection 210 and the busbar when the multi-pole connecting cable is slid in. These three spring terminals 120 are simultaneously opened by a single actuation of the lever switch 110 (e.g. all spring arms 121 are simultaneously forced in the plug-in direction R by means of the rod-shaped elements 132).

In the exemplary embodiments, as shown in FIG. 1A, the cable-connecting device 100 exhibits a total of three contact connections 210 to three busbars that are suitable for example for a three-phase power connection. The busbars can be contacted at a holder 220 at a lower side (in the plug-in direction R) and are not shown in FIG. 1A. In addition, the leaf springs can also exhibit two opposite leaves 121, 122 that can be forced together counter to the spring force. The forcing-together can for example be effected by exerting a force on the lever arm 112 of the lever switch 110, the force being further transferred via the connecting structure 130 (e.g. via the exemplary rod-shaped elements 132) to the spring arm 121 there to effect a bending of the spring arm 121 if for example the user actuates the lever switch 110.

The spring force of the spring terminals 120 is for example selected to be sufficiently high so that independent loosening of the contact of the multi-pole connecting cable between the spring arm 121 and the other leg 126 of the U-shaped connecting part 124 is prevented and a secure contact is achieved between the connecting cable and the busbar adapter. The contact advantageously resists a pulling force that acts on the connecting cable counter to the plug-in direction R, the pulling force that can be tolerated for example corresponding to a force that a user applies during unintended pulling-out.

This can for example be achieved in that on the surface of the spring arm 121 a structure is formed that increases the friction between the spring arm 121 and the respective line of the multi-pole connecting cable. As an option, it is also possible that the respective cable is clamped by the spring arm 121 into the U-shaped connecting piece 124 that establishes the connection to the contact connection 210, so that it cannot be moved counter to a plug-in direction R or can only be moved if the spring arm 121 is forced away. Such clamping-in results in a locking. In this exemplary embodiment, during removal of the connecting cable from the adapter, it is at first necessary that the spring arm 121 is forced in the plug-in direction R so as to release the respective line.

FIG. 1B shows the cable-connecting device 100 of FIG. 1A from an opposite side so that the spring-terminal structure 120 having a total of three spring terminals 120a, 120b, 120c is visible that are contacted by the rod-shaped elements 132. In this exemplary embodiment, the rod-shaped elements 132 are interconnected by a bridge 133 so that the bridge 133 is forced downward to the spring terminals 120 (i.e. in the insertion direction R) by actuating the lever switch 110 or the lever arm 112. In the actuated state of the lever switch 110, it is thus the three illustrated spring terminals 120 that are separated from a corresponding contact 210a, 210b, 210c of the contact connection 210 and thus permit the multi-pole connecting cable to be guided-in in a single working step.

FIG. 1C illustrates an enlarged detail of an adapter 200 (the further details of the adapter are illustrated in FIGS. 3A-3I), the cable-connecting device 100 being inserted into an only partly visible housing 205 of the adapter 200. The housing 205 comprises three openings: a first opening 201, a second opening 202, and a third opening 203, into which a three-pole connecting cable can be inserted. The housing 205 can for example exhibit an upper deck and a lower deck, in FIG. 1C the upper deck having been removed and only the lower deck being visible.

The housing 205 exhibits at least one projection 216 (or hook) at an end face of the housing 205 to thereby offer a stop for the lever switch 110. On top of this, the lever switch 110 having the supporting structure 114 that is not visible in FIG. 1C is propped by a supporting element 214 (or supporting structure), so that on account of the combination of the projection 216 and the supporting element 214 the lever arm 112 is retained in the housing 205 and can move or rotate only in the plug-in direction R. Here the projection 216 engages into the step-shaped depression 116 of the lever switch and blocks a vertical direction (counter to the spring tension).

In this way, the supporting element 214 and the projection 216 form holding means that define a stop and a pivot for the propping section 114 so that the lever arm 112 is held in the housing 205 by the projection 216 and by the supporting section 214 counter to the spring force, if for example the upper deck is removed (as it is shown in FIG. 1C). During disconnection (or in the unforced state) the lever switch 110 thus assumes a zero position as a result of the spring force of the spring-terminal structure 120, in which zero position the connecting cable having the at least two poles is held in the openings 201, 202, 203.

Therefore the lever switch 110 always remains firmly anchored in the lower-deck element 240 due to the projection 216 and the supporting element 214, even if the upper-deck element 260 is disconnected, since for disconnecting and removing the upper-deck element at first the connecting cables have to be removed from the openings 201, 202, 203 and the spring arms 121 press against the propping rods 132 and the latter in turn against the lever switch 110.

FIG. 1D illustrates the same part section of the adapter 200 that can be seen in FIG. 1C, in FIG. 1D the lever switch 110 having been actuated so that the lever arm 112 has moved downward in the view of Figure ID (in the plug-in direction R) and the step-shaped depression 116 on the lever switch 110 has been disconnected from the projection 216 and at the same time the connecting structure 130 having the rod-shaped elements 132 having moved along the movement direction of the lever arm 112 in the plug-in direction R. In the case of this lever movement, the supporting element 214 serves as a support for the propping structure 114, so that the lever arm 112 forms a lever and the lever force moves the connecting structure 130 downward at the fulcrum P.

FIGS. 2A and 2B show the insertion of the multi-pole connecting cable 300 into the adapter 200. In the exemplary embodiment as illustrated in FIG. 2, the multi-pole connecting cable 300 exhibits three lines for, for example, three phases, i.e. a first line 301, a second line 302, and a third line 303. The adapter 200 comprises the housing 205 having the three openings 201, 202, 203 that receive the three lines 301, 302, 303 during insertion, the first line 301 being inserted into the first opening 201, the second line 302 into the second opening 202, and the third line 303 into a third opening 303 of the adapter 200. The openings 201, 202 and 203 in the housing 205 define the insertion direction R, that is at right angles thereto, of the multi-pole connecting cable 300 into the busbar adapter 200.

On top of this, the housing 205 exhibits a further opening 207 for the lever arm 112 that protrudes from the further opening 207 of the adapter 200 so that the user, by actuating the lever arm 112 (for example by forcing into the plug-in direction R), can contact the three lines 301, 302 and 303 by means of the cable-connecting device 100 (that is not visible in FIG. 2A).

FIG. 2B shows the result after the insertion of the multi-pole connecting cable 300 into the adapter 200, the three lines 301, 302 and 303 having been fully inserted into the three openings 201, 202 and 203.

The adapter 200, as it is visible in FIGS. 2A and 2B, also exhibits a lower-deck element 240 and an upper-deck element 260, it being possible to interconnect the two deck elements 240, 260 releasably. The lower-deck element 240 comprises fastening elements 222 for fastening the adapter 200 on busbars, the adapter 200 illustrated in the figures being an adapter for a three-pole system, so that a total of three fastening elements 222 is provided for fastening on a total of three contact connections for busbars. The upper-deck element 260 comprises holding webs 480 that extend in the longitudinal direction (vertically in FIG. 2A) on which a supporting rail 600 is fastened that can be attached to the upper-deck element 260 in a different position and serves to receive electrical appliances, in particular electrical installation appliances such as, for example, switch-fuse units. No further details have been illustrated for the upper deck 260 and the lower deck 240, since they are of no importance for understanding the present invention.

In the exemplary embodiment of FIG. 2, the connecting cable 300 exhibits a plug 310 that keeps the exemplary three lines at a predetermined distance in parallel from each other. The plug 310 is for example designed such that the three lines, in insulated manner, enter in parallel on one side of the plug and leave it again, after having passed it, on the opposite side of the plug 310. The plug 310 is arranged at a predetermined distance D from one end of the three lines, so that the plug 310 contacts the housing 205 of the adapter 200 after the lines have been inserted into the adapter 200 and thus indicates to the user that the connecting cable 300 is fully inserted.

On top of this, the lines exhibit at their end points in each case an exposed section L that is designed to be contacted by the spring terminals 120 when the cable is guided into the cable-connecting device 100. Advantageously, the longitudinal extent of the exposed section L is dimensioned such that contacting with the spring terminals 120 along the exposed section L is made possible, that however the exposed section L cannot be contacted from outside after insertion. For example, the three lines can be arranged in a plane with equal distances from each other.

FIGS. 3A to 3I show different cross-sectional views of the adapter 200, a first cross-sectional view referring to the sectional plane A-A (see FIG. 3B), a second cross-sectional view referring to the sectional plane B-B (see FIG. 3C), a third cross-sectional view referring to the sectional plane C-C (see FIG. 3D), and a fourth cross-sectional view referring to the sectional plane D-D (see FIG. 3E). FIG. 3A further shows the first opening 201, the second opening 202, and the third opening 203, the second opening 202 being arranged between the first opening 201 and the third opening 203 and the first to third openings 201 to 203 being designed so as to receive the first to third lines 301, 302, 303 of the multi-pole connecting cable 300.

FIG. 3B shows the cross-sectional view along the cross section A-A that extends along the plug-in direction R and through the second opening 202 between the first opening 201 and the third opening 203.

As FIG. 3B shows, the spring terminal 120 exhibits a first arm 121 and a second arm 122 and the second opening 202 extends up to the first spring arm 121 of the spring terminal 120, while the second arm 122 of the spring terminal is connected to the U-shaped connecting piece 124 and is propped by the U-shaped connecting piece. When the lever arm 112 is actuated, a second of the three rod-shaped elements 132b of the connecting structure 130 is pressed downward in the plug-in direction R and the first spring arm 121 is forced away in the plug-in direction R so as to provide an opening for the second line 302 of the connecting cable 300. FIG. 3B further shows that the lever switch 110 couples the connecting structure 130 to the fulcrum P, so that during actuation of the lever arm 112 by the user a force acts on the fulcrum P that is transferred to the spring terminal 120. The connecting structure 130 is guided into the adapter 200 by a guide structure 232 in parallel to the plug-in direction R. In addition, a compression spring 137 can be arranged between the connecting structure 130 and the lever switch 110, that pretensions the connecting structure 130 and the lever switch 110 counter to each other so that they are never loosely seated and the lever switch 110 is forced into a zero position.

FIG. 3C shows a cross-sectional view along the cross-sectional line B-B and extends through the first opening 201. The lever arm 112 is not visible along this cross-sectional plane, but it is only a first rod-shaped element 132a of the connecting structure 130 that is visible and that in turn is coupled to the first spring terminal 121 and forces the latter into the plug-in direction R when the lever switch 110 is actuated. In this way, simultaneously with the opening of the second contact for the second line 302 it is likewise the first contact for the first line 301 that is opened, to be precise by one-time actuation of the lever arm 112 by the user.

FIG. 3D shows a cross-sectional view along the cross-sectional plane C-C that is situated laterally outside the three openings 201, 202 and 203 and thus does not show the contact connection in the adapter 200.

FIG. 3E shows a cross-sectional view along the cross-sectional line D-D (see FIG. 3A) that is arranged at right angles to the cross-sectional planes A-A, B-B, C-C and does not encompass any of the three openings 201, 202, 203, but extends in the extension plane of the connecting structure 130. For this reason, the lever switch 110 is only illustrated along the fulcrum P in FIG. 3E. The connecting structure 130 exhibits a bridge 133 that interconnects the first rod-shaped element 132a, the second rod-shaped element 132b, and a third rod-shaped element 132c, the fulcrum P for the lever switch 110 being formed as a line along a surface of the bridge 133. Therefore all three connecting rods 132 (rod-shaped elements) are simultaneously forced downward in the plug-in direction R when the lever is actuated, so that all three contacts are simultaneously opened to thereby enable the lines of the multi-pole connecting cable 300 to be received. FIG. 3E illustrates the spring terminal 120 only in a cross section, and to be precise in that area in which the spring terminals 120 contact the rod-shaped elements 132a, 132b, 132c.

FIGS. 3F and 3H show further top views of the adapter 200, where a sectional line E-E and a sectional plane F-F are defined, the corresponding sectional views being visible in FIGS. 3G and 3I. In contrast to the sectional view of FIG. 3A, 3B, the lever switch 110 is illustrated in the pressed view in FIGS. 3F-3I, so that in the sectional view of FIGS. 3G and 3I the lever arm 112 is moved toward the left. By pressing the lever arm 112, the connecting structure 130 is thus moved in the plug-in direction R by the lever force that acts on the fulcrum P and thereby forces the spring-terminal structure 120 together so that the openings for receiving the multi-pole connecting cable are open (cf. FIG. 3G with FIG. 3B, where the spring-terminal structure blocks the opening). FIGS. 3G and 3I further show the projection 216 as part of the holding means that is formed as a hook on the housing 205 and is not in contact with the lever switch in the pressed state of the lever arm 112. In addition, FIGS. 3G and 3I show the supporting element 214 that is likewise connected to the housing 205 and is in contact with the lever switch 110, to provide a pivot so that the leverage of the lever switch 110 acts at the fulcrum P.

After the lever switch 110 has been loosened, the lever arm 112 moves counter to the plug-in direction R (toward the right) until the lever arm 112, for example due to the step-shaped depression 116, again abuts the projection 216 and remains secured in this position (zero position).

FIG. 3J shows a further exemplary embodiment where a compression spring 137 provides a restoring force for the lever switch 110 for that case when the lines 301, 302, 303 are plugged in. FIG. 3J specifically again illustrates a sectional view in the sectional plane A-A as shown in FIG. 3B, but with an inserted connecting cable 300 and is therefore referred to as A′-A′. Since therein the spring arms 121 can no longer exert any spring pressure on the propping rods 132 and in continuation on the lever switch 110, the lever switch 110 and the propping rods 132 would mutually be in a slack bond. This circumstance could in particular under resonance oscillations lead to a rattling sound. For this reason, there is advantageously seated between the propping rods 132 and the lever switch 110 a weakly designed compression spring 137 that always forces the lever switch 110 upward (i.e. counter to the plug-direction R into the zero position). The compression spring 137 can for example be fitted in a depression (e.g. a blind hole) of the supporting rods 132.

The features of the invention, disclosed in the description, the claims and the drawings, can be essential both individually and also in any combinations for the realization.

What is claimed is:

1. An adapter (200) for contacting busbars with a connecting cable (300), the connecting cable (300) comprising at least two poles (301, 302), the adapter (200) having the following features:
at least two contact connections (210) for at least two busbars;
a housing (205) having holding means (214, 216) and at least two openings (201, 202) to receive in each case one pole of the connecting cable (300) through each of the at least two openings (201, 202);
a cable-connecting device (100) that is secured in the housing (205) by the holding means (214, 216), the cable-connecting device (100) comprising:
a lever switch (110) having a fulcrum (P) onto which a leverage acts when the lever switch (110) is actuated;
a spring-terminal structure (120) that provides at least one spring force for establishing an electrical contact between one of the at least two poles (301, 302) and one of the at least two contact connections (210) by the spring force after inserting the connecting cable (300); and
a connecting structure (130) that is arranged between the lever switch (110) and the spring-terminal structure (120) and is designed for transferring the leverage from the lever switch (110) to the spring-terminal structure (120) and to tension the spring-terminal structure (120) counter to the spring force, so that as a result of single actuation of the lever switch (110) the at least two poles (301, 302) of the connecting cable (300) can be simultaneously guided into the cable-connecting device (100) and on releasing the lever switch (110) the respective electrical contact is established between the at least two contact connections (210) and the at least two poles (301, 302) due to the spring force.

2. The adapter (200) according to claim 1, the connecting structure (130) comprising a one-part design and at least two rod-shaped elements (132), the at least two rod-shaped elements (132) being designed to contact the spring-terminal structure (120) when the leverage acts and to tension it by transmitting the leverage, so that an inserted connecting cable (300) can be removed from the cable-connecting device (100).

3. The adapter (200) according to claim 1, wherein the lever switch (110) further comprises a lever arm (112) for actuation by a user and a propping section (114), the fulcrum (P) being arranged between the lever arm (112) and the propping section (114) and the propping section (114) coupling to the holding means (214) for defining a pivot, so that the leverage acts on the fulcrum (P) due to a rotation about the pivot when the lever switch (110) is actuated by the user.

4. The adapter (200) according to claim 3, the wherein the lever switch (110) further comprises a step-shaped depression (116) and the holding means comprises a projection (216) and a supporting element (214) that are designed for forcing, due to the spring force, the step-shaped depression (116) of the lever switch (110) against the projection (216) with the propping section (114) against the supporting element (214) for thus forming a stop for the lever switch (110) in the housing (205).

5. The adapter (200) according to claim 1, wherein the housing (205) further comprises a lower deck (240) and a removable upper deck (260) and the holding means (214, 216) being formed on the lower deck (240).

6. The adapter (200) according to claim 1, wherein the spring-terminal structure (120) provides said at least one spring force sufficient for independently holding the connecting cable (300) in the busbar adapter (200) counter to a pulling force.

7. The adapter (200) according to claim 1, wherein the spring-terminal structure (120) is designed for wedging the connecting cable (300) after guiding the connecting cable (300) in, to block the connecting cable (300) from being pulled out of the cable-connecting device (100).

8. The adapter (200) according to claim 1, wherein the spring-terminal structure (120) further comprises a leaf spring and U-shaped contact connection (124) having two legs (125, 126) that are opposite each other, the leaf spring being secured to one of the legs (125) such that the spring force acts at least partly in the direction of the other leg (126), to contact the at least two poles of the connecting cable (300) by the leaf spring and the other leg (126).

9. The adapter (200) according to claim 1, wherein the housing (205) further comprises a lateral opening (207) and the lever switch (110) comprises a lever arm (112) that protrudes through the lateral opening (207) from the housing (205) and wherein the at least two poles (301, 302) are three poles and the spring-terminal structure (120) exhibits three mutually electrically insulated spring terminals, so that a three-phase connecting cable (300) can be simultaneously connected for all phases.

10. The adapter (200) according to claim 9, wherein the connecting structure (130) further comprises three rod-shaped elements (132) and the adapter (200) further comprises a guide structure (232) for the three rod-shaped elements (132), so that the three rod-shaped elements (132) can be moved in the guiding-in direction (R) of the connecting cable (300) when the lever switch (110) is actuated.

11. The adapter (200) according to claim 1, further comprising a spring (137) located between the lever switch (110) and the connecting structure (130), that forces the lever switch (110) away from the connecting structure (130), so as to keep the lever switch (110) tensioned by the holding means (214, 216) in the housing (205).

12. A connecting cable (300) for use with the adapter (200) according to claim 1, the connecting cable (300) comprising at least two lines (301, 302) and a plug (310), the plug (310) maintaining the at least two lines (301, 302) at a predetermined distance from each other, the predetermined distance being selected such that the at least two lines (301, 302) can be guided into the openings (201, 202) of the adapter (200).

13. The connecting cable (300) according to claim 12, wherein the at least two lines (301, 302) are three lines (301, 302, 303) that are arranged in parallel in a plane and the plug (310) for arranging the three lines (301, 302, 303) in parallel in the plane such that two of the three lines (301, 303) exhibit an approximately identical distance from an intermediate line (302).
